(19) United States
(12) Patent Application Publication
(10) Pub. No.: US 2014/0088907 A1
(43) Pub. Date: Mar. 27, 2014

(54) INERTIAL SENSOR AND METHOD FOR CORRECTING THE SAME

(71) Applicant: SAMSUNG ELECTRO-MECHANICS CO., LTD., Suwon (KR)

(72) Inventors: Seung Mo Lim, Suwon (KR); Yun Sung Kang, Suwon (KR); Sang Jin Kim, Suwon (KR); Sung Jun Lee, Suwon (KR); Kyo Yeol Lee, Suwon (KR)

(73) Assignee: SAMSUNG ELECTRO-MECHANICS CO., LTD., Suwon (KR)

(21) Appl. No.: 13/770,996

(22) Filed: Feb. 19, 2013

(30) Foreign Application Priority Data
Sep. 21, 2012 (KR) 10-2012-0105398

(51) Int. Cl. G01P 21/00

(52) U.S. Cl. CPC G01P 21/00
USPC 702/104

(57) ABSTRACT

Disclosed herein is a method for correcting an inertial sensor, including: (A) analyzing, by a computer, an inertial sensor; (B) detecting inertia moments at both sides based on a driving reference axis of the inertial sensor; (C) determining, by the computer, whether the inertia moment or a mass center is regularly symmetrical with each other at both sides based on the driving reference axis; and (D) correcting, by the computer, design information of the inertial sensor so that the inertia moment or the mass center is regularly symmetrical with each other based on the driving reference axis.

### CROSS REFERENCE TO RELATED APPLICATION

This application claims the benefit of Korean Patent Application No. 10-2012-0105398, filed on Sep. 21, 2012, entitled “Inertial Sensor and Method for Correcting the Same”, which is hereby incorporated by reference in its entirety into this application.

### BACKGROUND OF THE INVENTION

1. Technical Field

The present invention relates to an inertial sensor and a method for correcting the same.

2. Description of the Related Art

An inertial sensor has been used in various fields, for example, the military, such as an artificial satellite, a missile, an unmanned aircraft, and the like, an air bag, vehicles such as an electronic stability control (ESC), a black box for a vehicle, and the like, motion sensing of a hand shaking prevention camcorder, a mobile phone, and a game machine, navigation, and the like.

The inertial sensor is classified into an acceleration sensor that may measure a linear motion and an angular velocity sensor that may measure a rotating motion.

Acceleration may be calculated by Newton's law of motion “F=ma”, where “m” represents a mass of a moving body and “a” is acceleration to be measured. Further, angular velocity may be calculated by Coriolis force “F=2mΩ×v”, where “m” represents the mass of the moving body, “Ω” represents the angular velocity to be measured, and “v” represents the motion velocity of the mass. In addition, a direction of the Coriolis force is determined by an axis of velocity v and a rotating axis of angular velocity Ω.

The inertial sensor may be divided into a ceramic sensor and a microelectromechanical systems (MEMS) sensor according to a manufacturing process. Among others, the MEMS sensor is classified into a capacitive type, a piezoresistive type, a piezoelectric type, or the like, according to a sensing principle.

In particular, as the MEMS sensor can be easily manufactured in a small size and a light weight by using a MEMS technology as described in Patent Document.

For example, the inertial sensor is being continuously developed from a uniaxial sensor capable of detecting only an inertial force for a single axis using a single sensor to a multi-axis sensor capable of detecting an inertial force for a multi-axis of two axes or more using a single sensor.

As described above, in order to implement a six-axis sensor detecting the multi-axis inertial forces, that is, three-axis acceleration and three-axis angular velocities using a single sensor, accurate and effective driving and control are required. However, the inertial sensor according to the related art is not driven based on a driving axis but is driven based on the other axis other than the driving axis during the driving process, such that noise, instability, crosstalk may occur during a sensing process.

### PRIOR ART DOCUMENT

### Patent Document

(Patent Document 1) Patent Document: Korean Patent Laid-Open Publication No. 2011-0072229 (laid-open published on Jun. 29, 2011)

### SUMMARY OF THE INVENTION

The present invention has been made in an effort to provide an inertial sensor corrected to be driven based on a driving axis.

Further, the present invention has been made in an effort to provide a method for correcting an inertial sensor to be driven based on a driving axis.

According to a preferred embodiment of the present invention, there is provided a method for correcting an inertial sensor, including: (A) analyzing, by a computer, an inertial sensor; (B) detecting inertia moments at both sides based on a driving reference axis of the inertial sensor; (C) determining, by the computer, whether the inertia moment or a mass center is regularly symmetrical with each other at both sides based on the driving reference axis; and (D) correcting, by the computer, design information of the inertial sensor so that the inertia moment or the mass center is regularly symmetrical with each other based on the driving reference axis.

The step (A) may include recognizing a structure, a position, and a mass of components including a plurality of electrodes, pads, and wirings that are formed on a piezoelectric body.

The step (A) may include analyzing whether the inertial sensor is resonated based on the driving reference axis and the other axis.

In the step (B), the inertia moments may be divided based on the driving reference axis and the inertia moments at both sides, respectively, based on the driving reference axis may be detected by calculating a value obtained by multiplying a mass m, of the components based on the driving reference axis by a vertical distance r, at which the components are spaced apart from each other based on the driving reference axis.

The step (D) may include: (D-1) reducing an area in which a plurality of electrodes formed on a piezoelectric body overlap with respect to the driving reference axis; and (D-2) adding a reinforce pattern to a space between the electrodes.

In the step (D), the area may be reduced to have a width of ⅓ to ½ in a direction of the driving reference axis.

According to another preferred embodiment of the present invention, there is provided an inertial sensor wherein an inertia moment or a mass center of components is regularly symmetrical with each other at both sides, respectively, based on a driving reference axis. The components may include a plurality electrodes, pads, and wirings that are formed on a piezoelectric body.

The electrode may have an overlapping area having a width of ⅓ to ½ with respect to the driving reference axis.

A reinforce pattern for correcting the inertia moment or a mass center may be formed between the electrodes.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flow chart for describing a method for correcting an inertial sensor according to a preferred embodiment of the present invention;

FIG. 2 is a top illustrative view of an inertial sensor for describing the method for correcting an inertial sensor according to the preferred embodiment of the present invention;

FIG. 3 is an illustrative view of a process of driving an inertial sensor for describing the method for correcting an inertial sensor according to the preferred embodiment of the present invention;

FIG. 4 is an illustrative view of the inertial sensor to which a correction process according to the method for correcting an inertial sensor according to the preferred embodiment of the present invention is applied;

FIG. 5 is a top view of the inertial sensor corrected by the method for correcting an inertial sensor according to the preferred embodiment of the present invention; and

FIG. 6 is an enlarged view of portion D of FIG. 5.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

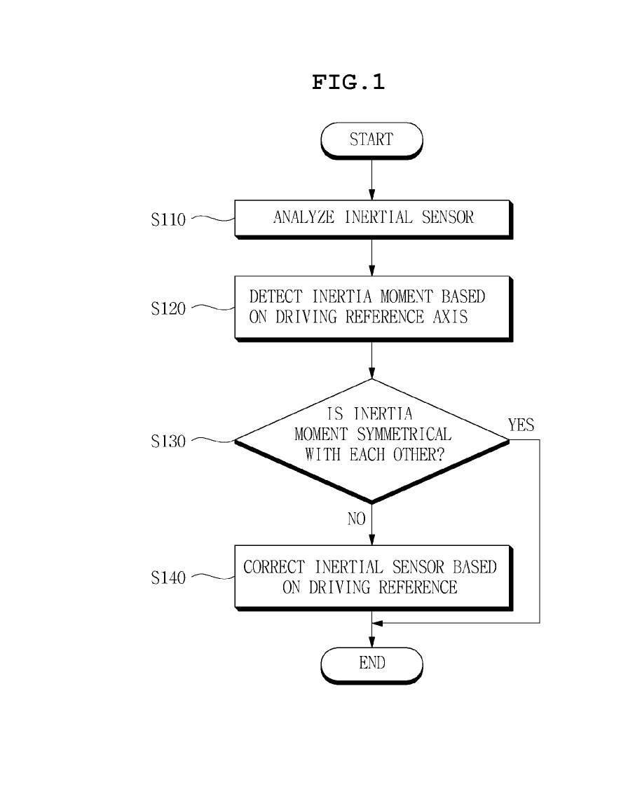

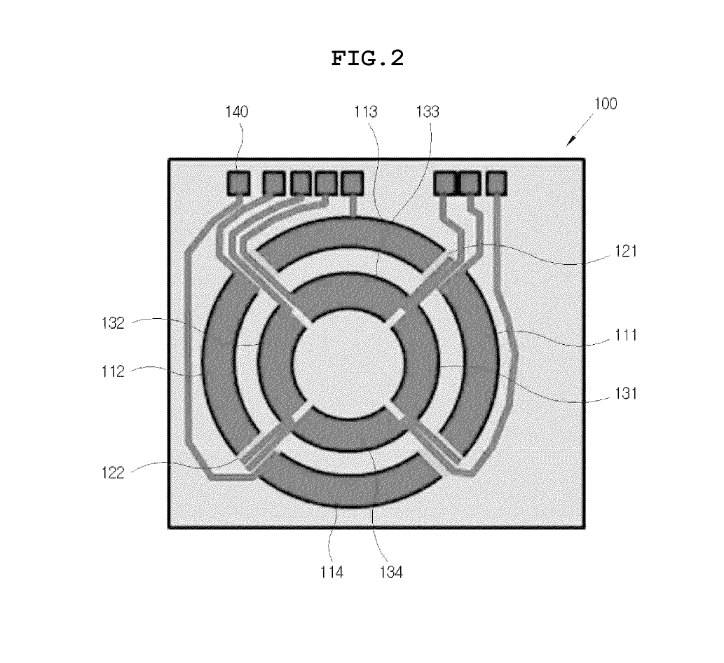

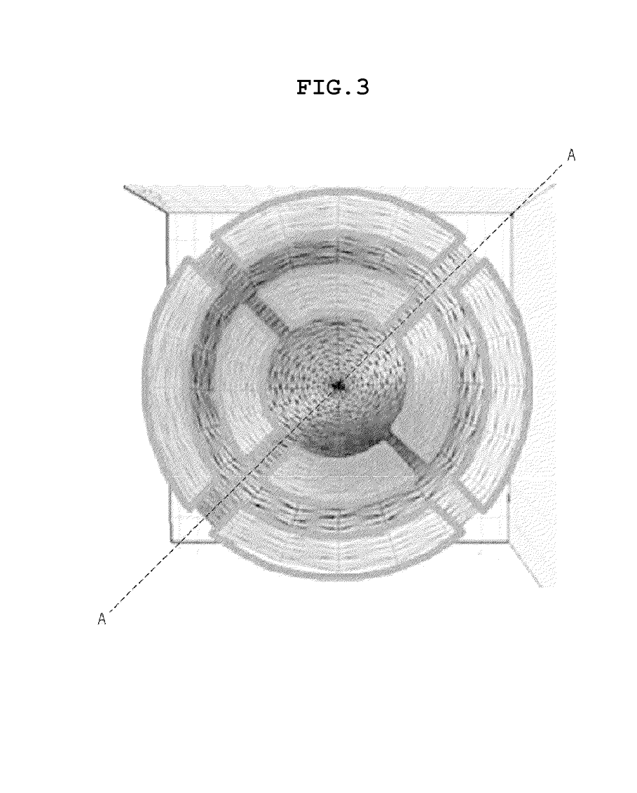

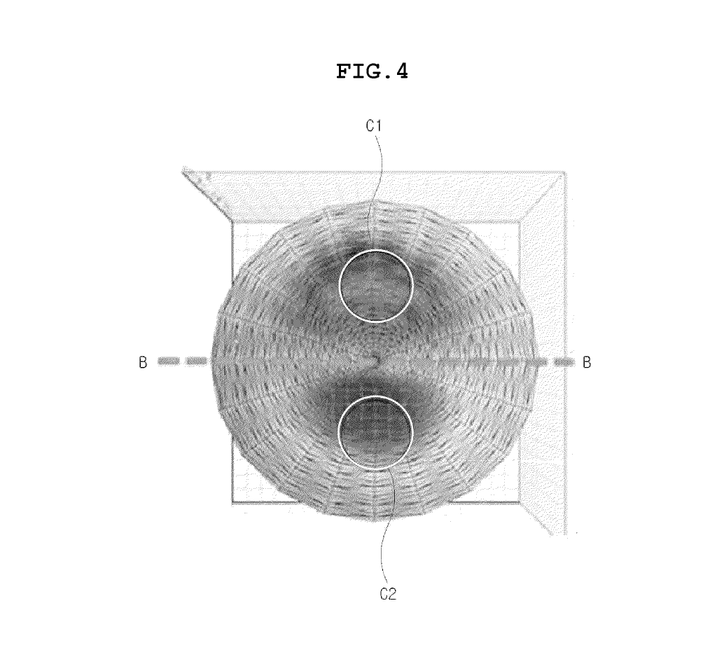

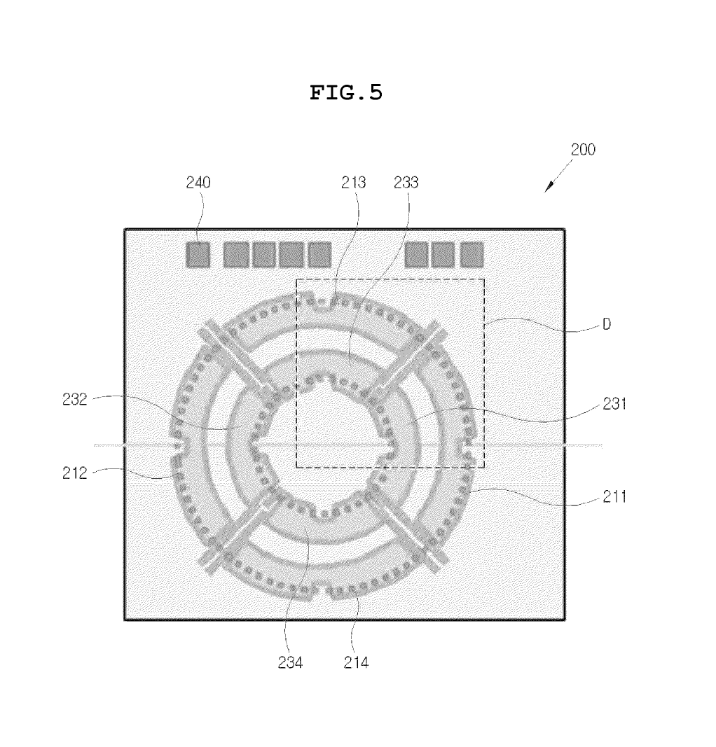

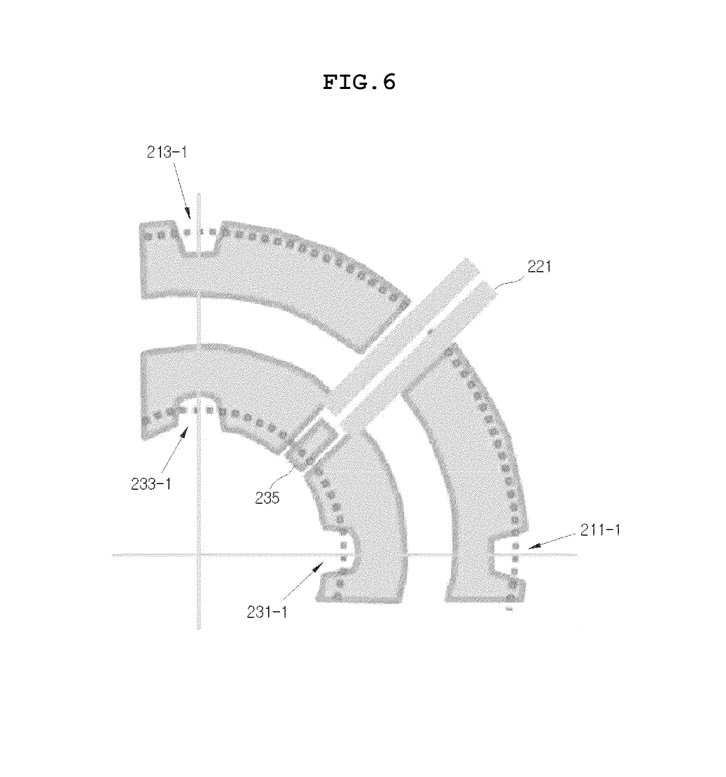

Hereinafter, preferred embodiments of the present invention will be described in detail with reference to the attached drawings. FIG. 1 is a flow chart for describing a method for correcting an inertial sensor according to a preferred embodiment of the present invention, FIG. 2 is a top illustrative view of an inertial sensor for describing the method for correcting an inertial sensor according to the preferred embodiment of the present invention, FIG. 3 is an illustrative view of a process of driving an inertial sensor for describing the method for correcting an inertial sensor according to the preferred embodiment of the present invention, FIG. 4 is an illustrative view of the inertial sensor to which a correction process according to the method for correcting an inertial sensor according to the preferred embodiment of the present invention is applied, FIG. 5 is a top view of the inertial sensor corrected by the method for correcting an inertial sensor according to the preferred embodiment of the present invention, and FIG. 6 is an enlarged view of portion D of FIG. 5.

Here, a method for correcting an inertial sensor according to a preferred embodiment of the present invention is performed in a processing apparatus such as, for example, a computer, and the like, such that a design correction of the inertial sensor may be performed in a state in which the processing apparatus is connected with the inertial sensor or in a state in which information regarding the inertial sensor is input to the processing apparatus.

Further, the information regarding the design corrected inertial sensor is transferred to a manufacturing apparatus connected to a computer and the inertial sensor may be manufactured according to correction information.

The method for correcting an inertial sensor according to the preferred embodiment of the present invention first analyzes an inertial sensor that is an object (S110).

For example, a computer may receive information regarding a structure and a size, a mass, a location, and the like, of each component of an inertial sensor 100 in a state in which the computer is connected to the inertial sensor 100 illustrated in FIG. 2. A shape of the inertial sensor 100 may be analyzed based on the information of the inertial sensor 100.

Therefore, as illustrated in FIG. 2, as the structure of the inertial sensor 100, a structure, a location, and a mass of a plurality of electrodes 111, 112, 113, 114, 131, 132, 133, and 134, a pad 140, wirings 121 and 122, and the like, that are formed on a piezoelectric body having a plate shape may be recognized.

In particular, a computer may recognize that four driving electrodes 111, 112, 113, and 114 are formed on the piezoelectric body, four sensing electrodes 131, 132, 133, and 134 as sensing units that are enclosed by the four driving electrodes 111, 112, 113, and 114 are formed, and the four driving electrodes and the four sensing electrodes each have an arc shape.

In detail, the computer may recognize that the four driving electrodes are configured of first driving electrodes 111 that are provided in both directions of an X axis and are symmetrical with each other based on an X axis, second driving electrodes 112 that are symmetrically disposed with the first driving electrodes 111 based on a Y axis, third driving electrodes 113 that are provided in both directions of a Y axis and are symmetrical with each other based on a Y axis, and fourth driving electrodes 114 that are symmetrically disposed with the third driving electrodes 113 based on an X axis.

After the computer recognizes the structure, the computer may apply voltage to the driving electrodes 111, 112, 113, and 114 to analyze a process of driving the inertial sensor 100.

In particular, the computer may analyze whether the inertial sensor 100 is resonated based on the other axis such as an A-A axis illustrated in FIG. 3, other than an X axis or a Y axis that is the driving reference axis.

The reason why the inertial sensor 100 is resonated based on the other axis such as the A-A axis is that an inertia moment is in an unbalance state based on the driving reference axis such as an X axis or a Y axis.

Here, the inertia moment is defined by

$${\sum }_{i} m {r}_{i}^{2}$$

in parenthesis like Equation 2 and is represented by I since all the components within a rigid body have the same ω², in Equation regarding kinetic energy (KR) of a rigid body generally described in Equation 1.

$${K}_{R} = \frac{1}{2} ( {\sum }_{i} {m}_{i} {r}_{i}^{2} ) {ω}^{2} = \frac{1}{2} I {ω}^{2} \qquad [ Equation 1 ]$$

(mᵢ=mass of each component configuring rigid body, rᵢ=vertical distance from rotating axis to each component, ω=angular velocity, I=inertia moment)

$$I = {\sum }_{i} {m}_{i} {r}_{i}^{2} \qquad [ Equation 2 ]$$

The inertia moment I represents a size of energy that allows a rotating or resonating rigid body to maintain a rotation or resonation state.

Here, the inertia moment I is present even in the inertial sensor 100 that is resonated based on the other axis illustrated in FIG. 3, but may be in an unbalance state based on the driving reference axis such as an X axis or a Y axis.

Therefore, since the inertia moment is in the unbalance state based on the driving reference axis such as an X axis or a Y axis, the inertial sensor 100 is resonated based on the other axis illustrated in FIG. 3.

Therefore, the computer detects the inertia moments at both sides based on the driving reference axis so as to determine whether the inertia moment is in an unbalance state based on the driving reference axis, in connection with the analyzed inertial sensor 100 (S 120).

For example, the inertia moments at both sides, respectively, are detected by calculating a value obtained by multiplying a mass m, of components recognized in the analyzing S110, that is, components such as the plurality of electrodes 111, 112, 113, 114, 131, 132, 133, and 134, the pad 140, the wirings 121 and 122, and the like, that are provided on the piezoelectric body for each region divided based on the driving reference axis such as an X axis or a Y axis by a vertical distance rᵢ at which the components are spaced apart from each other based on the driving reference axis.

In particular, the computer detects the inertia moment and may also detect a position of a mass center for the mass mᵢ of components such as the plurality of electrodes 111, 112, 113, 114, 131, 132, 133, and 134, the pad 140, the wirings 121 and 122, and the like, that are disposed on the piezoelectric body of the inertial sensor 100.

In detail, the mass center C may be obtained by dividing a value obtained by multiplying and summing the mass m, of each component disposed on the piezoelectric body by the vertical distance r, at both sides, respectively, based on the driving reference axis of the inertial sensor 100 like Equation 3 by a summed mass M of the components at both sides, respectively, based on the driving reference axis.

$$C = \frac{1}{M} {\sum }_{i} {m}_{i} {r}_{i} \qquad [ Equation 3 ]$$

(mᵢ=mass of each component, rᵢ=vertical distance from driving reference axis to each component, M=summed mass of components at both sides, respectively, based on driving reference axis)

The computer determines whether the inertia moment I and the mass center C are regularly symmetrical with each other at both sides based on the driving reference axis, by using the detected inertia moment I and mass center C (S130).

That is, the computer may determine whether the inertia moment I and the mass center C are regularly symmetrical with each other based on the driving reference axis of B-B corresponding to the X axis in the inertial sensor 100, like simulation illustrated in FIG. 4.

In particular, the computer may determine whether the mass centers at both sides, respectively, based on the driving reference axis, that is, a mass center C1 of one region and a mass center C2 of the other region are regularly symmetrical with each other based on the driving reference axis of B-B.

Further, the computer may also determine whether the inertia moment I and the mass center C are regularly symmetrical with each other based on the driving reference axis corresponding to a Y axis or a Z axis other than the driving reference axis of B-B corresponding to an X axis.

As the determination result of the determining (S130), if it is determined that the inertia moment I and the mass center C are regularly symmetrical with each other at both sides based on the driving reference axis, the computer corrects the inertia moment I and the mass center C so as to be regularly symmetrical with each other based on the driving reference axis of the inertial sensor (S 140).

In detail, like an inertial sensor 200 illustrated in FIG. 5, the computer may correct the inertial sensor so that the inertia moment I and the mass center C are regularly symmetrical with each other at both sides based on the driving reference axis.

For example, in order to correct the inertia moment I and the mass center C so as to be regularly symmetrical with each other, the computer may correct the inertia moment I and the mass center C by changing shapes of components disposed on a piezoelectric body of the inertial sensor 200, that is, four driving electrodes 211, 212, 213, and 214, four sensing electrodes 231, 232, 233, and 234, and wirings, respectively.

That is, the computer may reduce an overlapping area of overlapping portions 211-1 and 213-1 of the four driving electrodes 211, 212, 213, and 214 and overlapping portions 231-1 and 233-1 of four sensing electrodes 231, 232, 233, and 234 with respect to the driving reference axis of an X axis or a Y axis in an enlarged view illustrated in FIG. 6 and may add a reinforce pattern to a space between four sensing electrodes 231, 232, 233, and 234.

For example, the computer may reduce the overlapping area so that the overlapping portions 211-1 and 213-1 of the four driving electrodes 211, 212, 213, and 214 and overlapping portions 231-1 and 233-1 of the four sensing electrodes 231, 232, 233, and 234 have a width of ⅓ to ½ in a direction of the driving reference axis.

Therefore, the mass distribution of components that are provided on the piezoelectric body of the inertial sensor 200 is changed so that the inertia moment I and the mass center C of the inertial sensor 200 may be correctly designed so as to be regularly symmetrical with each other based on the driving reference axis of an X axis or a Y axis.

In addition, the computer changes a plurality of pads 240 and a connection structure of wirings connected with the four driving electrodes 211, 212, 213, and 214 and the four sensing electrodes 231, 232, 233, and 234 from each pad 240 as illustrated in FIG. 5 so that the inertia moment I and the mass center C may be correctly designed so as to be regularly symmetrical with each other based on the driving reference axis of an X axis or a Y axis.

Therefore, the inertial sensor 200 corrected based on the method for correcting an inertial sensor according to the preferred embodiment of the present invention is changed so that the four driving electrodes 211, 212, 213, and 214 and the four sensing electrodes 231, 232, 233, and 234 have a symmetrical structure with each other based on the driving reference axis of an X axis or a Y axis, in particular, the inertia moment I and the mass center C are regularly symmetrical with each other based on the driving reference axis.

The corrected inertial sensor 200 may reduce the inertia moment of the overlapping portion with the driving reference axis to facilitate resonance based on the driving reference axis and make the mass center C to be regularly symmetrical based on the driving reference axis by a pattern that adds the mass like the reinforce pattern 235.

Therefore, the inertial sensor 200 that makes the inertia moment I and the mass center C to be regularly symmetrical based on the driving reference axis is easily driven based on the driving reference axis, thereby preventing noise, instability, cross talk from occurring due to the other axis during the sensing process.

According to the method for correcting an inertial sensor according to the preferred embodiments of the present invention, it is possible to provide the inertial sensor in which the inertia moment and the mass center are regularly symmetrical with each other based on the driving reference axis.

The inertial sensor corrected according to the exemplary embodiment of the present invention can be easily driven based on the driving reference axis, thereby preventing noise, instability, or crosstalk from occurring due to the other-axis driving during the sensing process.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A method for correcting an inertial sensor, comprising:
(A) analyzing, by a computer, an inertial sensor;
(B) detecting inertia moments at both sides based on a driving reference axis of the inertial sensor;
(C) determining, by the computer, whether the inertia moment or a mass center is regularly symmetrical with each other at both sides based on the driving reference axis; and
(D) correcting, by the computer, design information of the inertial sensor so that the inertia moment or the mass center is regularly symmetrical with each other based on the driving reference axis.

2. The method as set forth in claim 1, wherein the step (A) includes recognizing a structure, a position, and a mass of components including a plurality of electrodes, pads, and wirings that are formed on a piezoelectric body.

3. The method as set forth in claim 1, wherein the step (A) includes analyzing whether the inertial sensor is resonated based on the driving reference axis and the other axis.

4. The method as set forth in claim 2, wherein in the step (B), the inertia moments are divided based on the driving reference axis and the inertia moments at both sides, respectively, based on the driving reference axis are detected by calculating a value obtained by multiplying a mass m, of the components based on the driving reference axis by a vertical distance r, at which the components are spaced apart from each other based on the driving reference axis.

5. The method as set forth in claim 1, wherein the step (D) includes:
(D-1) reducing an area in which a plurality of electrodes formed on a piezoelectric body overlap with respect to the driving reference axis; and
(D-2) adding a reinforce pattern to a space between the electrodes.

6. The method as set forth in claim 5, wherein in the step (D-1), the area is reduced to have a width of ⅓ to ½ in a direction of the driving reference axis.

7. An inertial sensor wherein an inertia moment or a mass center of components is regularly symmetrical with each other at both sides, respectively, based on a driving reference axis.

8. The method as set forth in claim 7, wherein the components include a plurality electrodes, pads, and wirings that are formed on a piezoelectric body.

9. The method as set forth in claim 8, wherein the electrode has an overlapping area having a width of ⅓ to ½ with respect to the driving reference axis.

10. The method as set forth in claim 8, wherein a reinforce pattern for correcting the inertia moment or a mass center is formed between the electrodes.
